(19) United States
(12) Patent Application Publication
(10) Pub. No.: US 2003/0126076 A1
(43) Pub. Date: Jul. 3, 2003

(54) Systems and methods for secure authorization of electronic transactions

(75) Inventors: Gilbert Kwok, Plano, TX (US); Charles M. Feltner, Plano, TX (US); Bing Lu, Plano, TX (US)

Correspondence Address: Roger S. Burleigh, MS/EVW2-C-2, 6300 Legacy Drive, Plano, TX, 75024, US

(73) Assignee: Telefonaktiebolaget L.M. Ericsson (publ)

(21) Appl. No.: 10/034,051

(22) Filed: Dec. 27, 2001

(51) Int. Cl. G06F 17/60

(52) U.S. Cl. 705/40; 705/39

(57) ABSTRACT

Systems and methods for providing secure mobile commerce transactions. A mobile device submits a request for an electronic transaction at a vendor system; the request includes a telephone number associated with the mobile device. The vendor system sends a request for authorization to a transaction authorization system. The transaction authorization system sends a request for confirmation to a messaging center associated with the wireless telephony system. The messaging center transmits a message to the mobile device associated with the telephone number; the message includes a request for a user of the mobile device to send a reply to the message to confirm the request for an electronic transaction. Upon receipt of a reply, the messaging center transmits a transaction confirmation to the transaction authorization system, which then transmits a transaction authorization message to the vendor system. The vendor system then initiates the completion of the requested electronic transaction.

### TECHNICAL FIELD OF THE INVENTION

The present invention is directed, in general, to wireless communications systems and, more specifically, to systems and methods for providing secure authorization of electronic transactions.

### BACKGROUND OF THE INVENTION

The world is currently experiencing revolutionary changes in communications systems, brought about, in part, by the general availability and evolution of wireless telephony systems and the Internet. As the capabilities of mobile telephones continues to increase, and more vendors establish an Internet presence, it is predeicted that mobile commerce, or “m-commerce,” will become commonplace.

One of the critical issues associated with the consumer adoption of m-commerce is security. Because the Internet is by nature an open and unsecure environment, many consumers are deterred from purchasing merchandise or services over the Internet because of the necessity of transmitting banking or credit card information to a merchant. The risks associated with direct transactions between a customer and an Internet vendor include: 1) the risk that the customer's banking or credit card information could be intercepted during transmission; 2) the possibility that a stolen credit card can be used to purchase merchandise or services; 3) the vulnerability of a vendor's database containing customer financial information; and 4) the risk of unauthorized transactions being charged to a customer's credit card in error by the vendor.

Accordingly, there is a need in the art for systems and methods to perform secure electronic transactions using a wireless telephony system; preferably, such systems and methods should eliminate the need for a user of a mobile device to transmit banking or credit card information to a merchant to complete an m-commerce transaction.

### SUMMARY OF THE INVENTION

To address the above-discussed deficiencies of the prior art, the present invention provides systems and methods related to performing secure electronic transactions using a wireless telephony system. An exemplary method according to the principles of the present invention includes the steps of: 1) receiving from a mobile device a request for an electronic transaction at a vendor system, wherein the request includes a telephone number associated with the mobile device; 2) transmitting, in response to receipt of the request for an electronic transaction, a request for authorization from the vendor system to a transaction authorization system; 3) transmitting, in response to receipt of the request for authorization, a request for confirmation from the transaction authorization system to a Short Message Service (SMS) center associated with the wireless telephony system; 4) transmitting, in response to receipt of the request for confirmation, a SMS message from the SMS center to the mobile device associated with the telephone number, wherein the SMS message includes a request for a user of the mobile device to send a reply to the SMS message to confirm the request for an electronic transaction; 5) receiving at the SMS center a reply to the SMS message from the mobile device; 6) transmitting, in response to receiving the reply to the SMS message, a transaction confirmation message from the SMS center to the transaction authorization system; 7) transmitting, in response to receiving the transaction confirmation message, a transaction authorization message from the transaction authorization system to the vendor system; and 8) initiating, in response to receiving the transaction authorization message, the electronic transaction at the vendor system.

In an exemplary embodiment, the transaction authorization system includes a database for storing User Profiles. A User Profile includes at least a telephone number and payment source information. Payment source information can be, for example, a bank or credit card account number of the user. The transaction authorization message can include the user's payment source information or, alternatively, the transaction authorization message can identify a payment source associated with the transaction authorization system.

In an exemplary embodiment, the request for confirmation and the SMS message include a request for the user to provide a user code. A user code can be, for example, a Personal Identification Number (PIN) associated with the user and stored in the User Profile. Alternatively, or in addition to a PIN, the user code could be based on user biometrics.

The foregoing has outlined, rather broadly, the principles of the present invention so that those skilled in the art may better understand the detailed description of the exemplary embodiments that follow. Those skilled in the art should appreciate that they can readily use the disclosed conception and exemplary embodiments as a basis for designing or modifying other structures and methods for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following detailed description taken in conjunction with the accompanying drawings, in which:

FIG. 1 illustrates a signaling diagram for an exemplary system for providing secure mobile commerce transactions in accordance with the principles of the present invention; and

FIG. 2 illustrates a flow chart of an exemplary method for providing secure mobile commerce transactions in accordance with the principles of the present invention.

### DETAILED DESCRIPTION

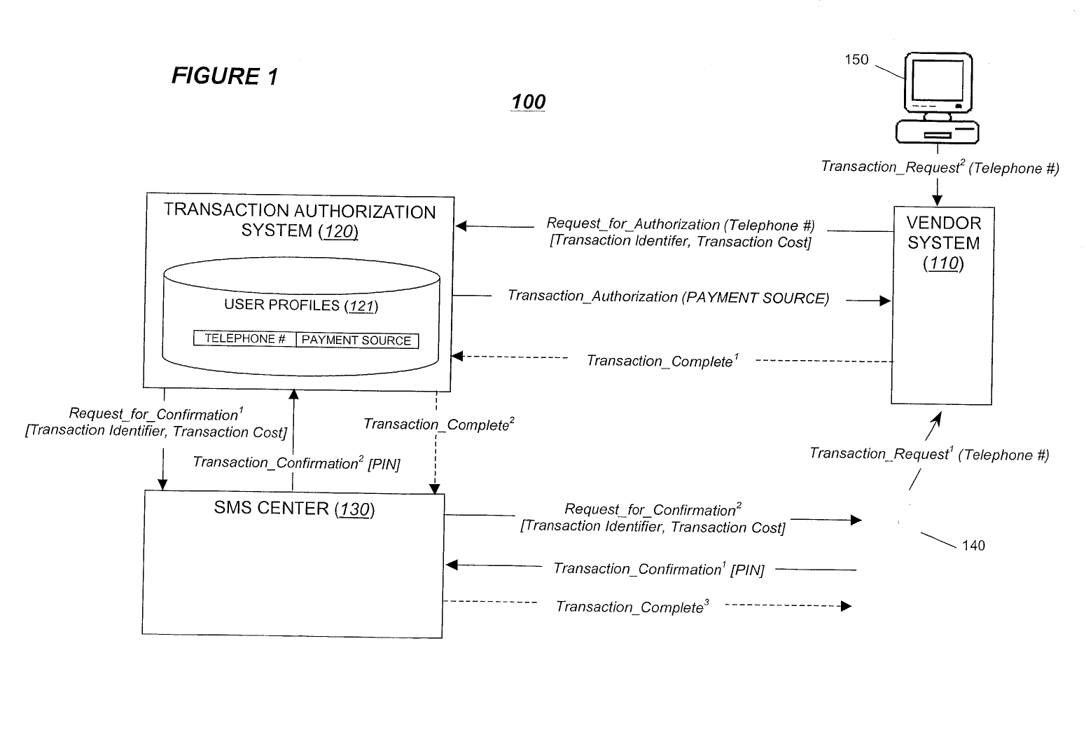

Referring to FIG. 1, illustrated is a signaling diagram for an exemplary system 100 for providing secure electronic transactions in accordance with the principles of the present invention. The exemplary system 100 includes a vendor system 110, a transaction authorization system 120 and a Short Message Service (SMS) service center 130. A wireless telephone, or device, 140 and/or a computer 150 have access to the vendor system 110 for executing electronic transactions.

The vendor system 110 can be, for example, an Internet web server that hosts a merchant site where persons can select goods and/or services for purchase. The merchant site can be viewed using, for example, a HyperText Markup Language (HTML) browser on computer 150 or a Wireless Application Protocol (WAP) browser on wireless telephone 140. In these embodiments, a user of wireless telephone 140 or computer 150 selects one or more products or services for purchase and sends a transaction request, Transaction_Request¹ or Transaction_Request², respectively, to the vendor system 110. The Transaction_Request includes the telephone number associated with wireless telephone 140. Once the transaction is authorized, as described hereinafter, the vendor system 110 will complete the transaction, for example, by shipping the selected product(s) to the customer.

In other embodiments, the vendor system 110 can be of a type that does not require a customer to use an HTML or WAP browser to view the products. For example, the vendor system 110 could be associated with a conventional vending machine, such as a snack machine. In such embodiments, the vending machine and wireless telephone can communicate directly using various wireless communications standards, such as the Infrared Data Association (IrDA) standard for transmitting data via infrared light waves, or the Bluetooth short-range radio technology. In these embodiments, once a communications link is established between the wireless telephone 140 and vendor system 110, a customer can select a product for purchase using the keypad of the wireless telephone to input a number associated with the desired product. The telephone number of the wireless telephone 140 can be provided automatically upon the establishment of the communication link, or it can be provided using the keypad of the wireless telephone. Once the transaction is authorized, as described hereinafter, the vending machine will dispense the selected product.

In a related embodiment, rather than establishing a communication link directly between the vending machine and the wireless telephone 140, the vendor system could also include a remote dial-in system. In this embodiment, a user of the wireless telephone 140 would dial a number provided on the vending machine to connect to the remote dial-in system. Once connected, the customer can select a product for purchase using the keypad of the wireless telephone to input a number associated with the desired product. The telephone number of the wireless telephone 140 can be obtained by the remote system using conventional Caller ID capability or, alternatively, the user can be prompted to enter the number using the telephone keypad. Once the transaction is authorized, as described hereinafter, the remote system would send a signal to the vending machine to dispense the selected product.

Once a customer has selected a product or service for purchase, the vendor system 110 transmits a request for authorization (Request_for_Authorization) to the transaction authorization system 120. The request for authorization includes the telephone number associated with wireless telephone 140, and may also include a merchant identifier, such as the vendor name or a unique transaction code, and/or the transaction cost.

In the exemplary system 100, the transaction authorization system 120 includes a user profiles database 121. Each profile in the database 121 includes at least a telephone number associated with a subscriber to the transaction authorization system. The telephone number in a profile identifies a telephone associated with the subscriber, such as wireless telephone 140. When a request for authorization of an electronic transaction is received from a vendor system 110, the transaction authorization system 120 queries the database 121 to verify that the telephone number in the request for authorization is associated with a subscriber. If the telephone number is in the database 121, the transaction authorization system 120 sends a request for confirmation message to the telephone identified by the telephone number; this message alerts a user of the telephone that authorization of an electronic transaction has been requested and allows the user to confirm or refuse the transaction. The request for confirmation can include the merchant identifier and/or the transaction cost.

In the exemplary embodiment illustrated in FIG. 1, the request for confirmation message (Request for_Confirmation¹) is routed to the telephone using a Short Message Service (SMS) center 130. SMS is a service for sending short text messages to mobile phones. The SMS center 130 relays the request for confirmation message (Request for_Confirmation²) to the wireless telephone 140. The request for confirmation message includes a request for a user of the wireless telephone 140 to send a reply to the message to confirm the request for an electronic transaction.

To confirm a transaction, the user of the wireless telephone 140 sends a reply (Transaction_Confirmation¹) to the received request for confirmation message. The SMS center 130 relays the reply (Transaction_Confirmation²) to the transaction authorization system 120. In a preferred embodiment, the request for confirmation can include a request that the user provide a user code, such as a Personal Identification Number (PIN), in a reply to the request for confirmation if the user desires to authorize the electronic transaction. In such embodiments, the user code can be stored in the user profile database 121. In such embodiments, upon receiving the transaction confirmation message (Transaction_Confirmation²), the transaction authorization system 120 checks the received code against the user code stored in the user profile database 121, and, if the codes match, the transaction authorization system 120 accepts the received transaction confirmation message.

When the transaction authorization system 120 receives a valid transaction confirmation message (Transaction_Confirmation²), it transmits a transaction authorization message (Transaction_Authorization) to the vendor system 110. In one embodiment, the user's profile in database 121 includes information that identifies a payment source for transactions. A payment source can be, for example, a credit card or bank account number. In such embodiments, the merchant directly bills the customer using their credit card or bank account number provided in the transaction authorization message. In an alternative embodiment, the payment source can be associated with the transaction authorization system 120. In such embodiments, a subscriber would have an agreement that would allow the provider of the transaction authorization system 120 to bill the subscriber for authorized transactions, and the provider would pay the merchant for such transactions. For example, the transaction authorization system 120 could be provided by the wireless communications network service provider, which would bill the subscriber for both the cost of their wireless service and authorized transactions. Alternatively, the transaction authorization system 120 could be provided by a financial institution, such as the issuer of a subscriber's credit card. In such embodiments, it is unnecessary to provide the subscriber's personal credit or banking information to the vendor system 110, thereby enhancing the security of the subscriber's private data.

Once the vendor system 110 has received a transaction authorization message, it can initiate completion of the requested electronic transaction. If the payment source is a credit card or bank account, this process can include conventional charge, or debit, authorization procedures. If the charge, or debit, is approved, the vendor system 110 can complete the order. In the exemplary system 100, the vendor system 110 sends a transaction complete message (Transaction_Complete¹) to the transaction authorization system 120; the transaction complete message can include, for example, an order confirmation number. The transaction authorization system 120 can then relay the transaction complete message to the wireless telephone 140; i.e., the transaction authorization system 120 sends a transaction complete message (Transaction_Complete²) to the SMS center 130, which relays the message (Transaction_Complete³) to the wireless telephone 140.

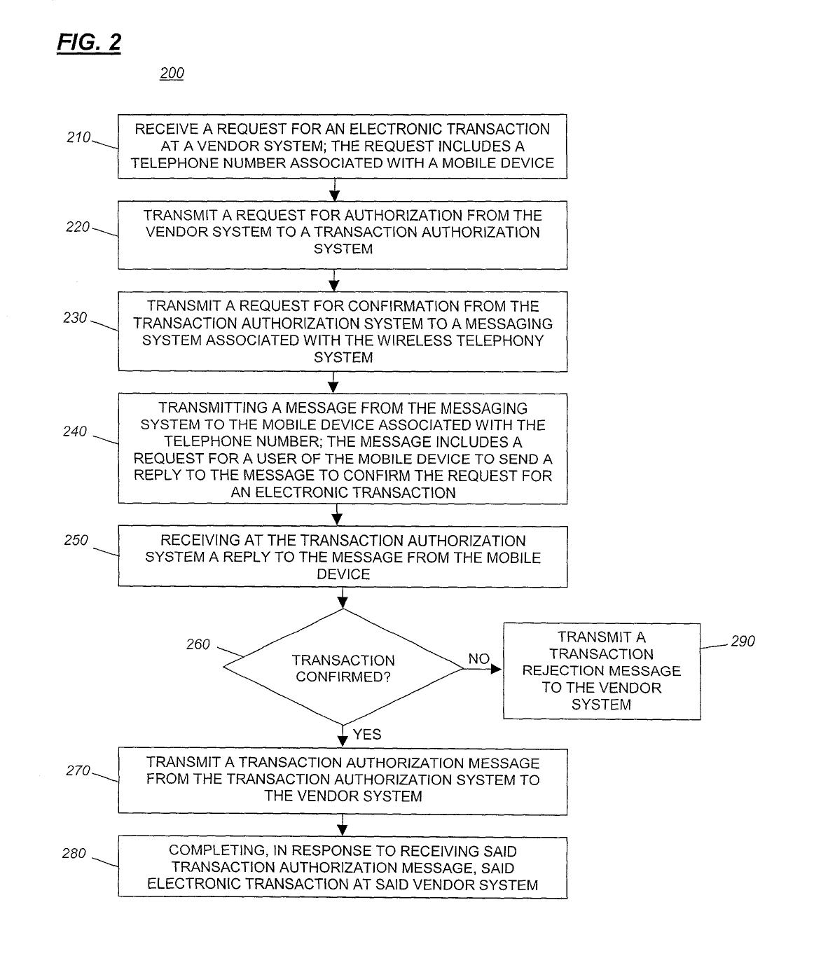

Turning now to FIG. 2, illustrated is a flow chart of an exemplary method 200 for providing secure mobile commerce transactions in accordance with the principles of the present invention. The processes identified in the method 200, as more fully described hereinabove, can be implemented in a general or special purpose computing system, including a processor, random access memory (RAM) coupled to the processor, non-volatile memory coupled to the processor, and an input/output subsystem coupled to the processor. The processor, RAM and non-volatile memory are operative to retrieve and execute digitally-coded instructions stored in the non-volatile memory, and to transmit and receive information to and from remote systems via the input/output subsystem. The digitally-coded instructions stored in the non-volatile memory are operative to cause the computing system to perform the steps identified in method 200. Those skilled in the art are familiar with the architecture and operation of general and specific-purpose computing systems and, thus, a detailed description is unncessary to an understanding of the invention disclosed herein.

The steps in the method 200 illustrated in FIG. 2 define the method for performing secure electronic transactions using a wireless telephony system as disclosed herein; the steps are not, however, implemented in one computing system, but are distributed between the vendor system 110, transaction authorization system 120 and SMS center 130.

In a first step 210, a request for an electronic transaction is received at a vendor system 110; the request includes a telephone number associated with a wireless telephone 140. The request for the electronic transaction can be from the wireless telephone 140 or from another electronic device, such as computer 150. In response to receipt of the request for an electronic transaction, a request for authorization is transmitted from the vendor system 110 to a transaction authorization system 120 (Step 220).

As described above, the transaction authorization system 120 includes a database of user profiles, each of which includes a telephone number. If the telephone number received with the request for authorization is in the database, the transaction authorization system 120 transmits a request for confirmation to a messaging system, such as SMS center 130, associated with the wireless telephony system (Step 230). The messaging system then transmits, or relays, this request for confirmation to the wireless telephone 140 associated with the telephone number; the message includes a request for a user of the wireless telephone to send a reply to the message to confirm the request for an electronic transaction.

If the user of the wireless telephone 140 desires to confirm the request for an electronic transaction, he or she sends a reply to the request for confirmation message. This reply is routed through the SMS center 130 and received by the transaction authorization system 120 (Step 250). The transaction authorization system 120 examines the reply to determine if the user of the wireless telephone 140 has confirmed the electronic transaction (Step 260); this step can include verifying that a user code entered by the user of wireless telephone 140 and included in the reply matches a code stored in the user's profile in database 121. If the transaction has been rejected, the transaction authorization server 120 transmits a rejection message to the vendor system 110 (Step 290). If the transaction has been confirmed, the transaction authorization system 120 transmits a transaction authorization message from to the vendor system 110 (Step 270). As described above, the transaction authorization message can include payment source information, which can be either credit or banking information of the user of wireless telephone 140 or of the operator of the transaction authorization system 120. The vendor system then completes the electronic transaction (Step 280).

From the foregoing, those skilled in the art will recognize that the present invention advances the state of the art of communications systems, providing systems and methods related to performing secure electronic transactions using a wireless telephony system. Although the present invention has been described in detail, those skilled in the art will conceive of various changes, substitutions and alterations to the exemplary embodiments described herein without departing from the spirit and scope of the invention in its broadest form. The exemplary embodiments presented herein illustrate the principles of the invention and are not intended to be exhaustive or to limit the invention to the form disclosed; it is intended that the scope of the invention only be limited by the claims appended hereto, and their equivalents.

What is claimed is:

1. A method for performing secure electronic transactions using a wireless telephony system, said method comprising the steps of:
receiving a request for an electronic transaction at a vendor system, said request including a telephone number associated with a wireless telephone;
transmitting, in response to receipt of said request for an electronic transaction, a request for authorization from said vendor system to a transaction authorization system;
transmitting, in response to receipt of said request for authorization, a request for confirmation from said transaction authorization system to a messaging system associated with said wireless telephony system, said messaging system transmitting, in response to receipt of said request for confirmation, a message to said wireless telephone associated with said telephone number, said message including a request for a user of said mobile device to send a reply to said message to confirm said request for an electronic transaction;
receiving at said transaction authorization system a reply to said message from said mobile device;
determining, from the content of said reply, whether a user of said mobile device has confirmed said electronic transaction; and
transmitting, in response to a confirmation of said electronic transaction, a transaction authorization message from said transaction authorization system to said vendor system; and
completing, in response to receiving said transaction authorization message, said electronic transaction at said vendor system.

2. The method recited in claim 1, wherein said request for an electronic transaction is transmitted to said vendor system from an electronic device other than said wireless telephone.

3. The method recited in claim 1, wherein said request for an electronic transaction is transmitted to said vendor system from said wireless telephone.

4. The method recited in claim 1, wherein messaging system associated with said wireless telephony system comprises a Short Message Service (SMS) center.

5. The method recited in claim 1, wherein said transaction authorization system comprises a database for storing User Profiles, each User Profile including at least a telephone number and payment source information.

6. The method recited in claim 5, wherein said payment source information comprises a credit card number.

7. The method recited in claim 5, wherein said transaction authorization message includes said payment source information.

8. The method recited in claim 1, wherein said request for authorization, said request for confirmation, and said message to said wireless telephone each include a merchant identifier associated with said electronic transaction.

9. The method recited in claim 1, wherein said request for authorization, said request for confirmation, and said message to said wireless telephone each include the cost of said electronic transaction.

10. The method recited in claim 1, wherein said request for confirmation and said message to said wireless telephone include a request for said user to provide a user code.

11. The method recited in claim 10, wherein said method further comprises the steps of:
comparing said user code to a code stored in a User Profile; and
sending a transaction rejection message to said vendor system if said user code is not identical to said code stored in said User Profile.

12. A transaction authorization system for performing secure electronic transactions using a wireless telephony system, said system comprising:
a computing system, including:
a processor;
random access memory (RAM) coupled to said processor;
non-volatile memory coupled to said processor; and
an input/output subsystem coupled to said processor, wherein said processor, RAM and non-volatile memory are operative to retrieve and execute digitally-coded instructions stored in said non-volatile memory, and to transmit and receive information to and from remote systems via said input/output subsystem; and
digitally-coded instructions stored in said non-volatile memory, said digitally-coded instructions operative to cause said computing system to perform the steps of:
receiving a request for authorization of an electronic transaction from a vendor system, said request for authorization including a telephone number associated with a mobile device;
transmitting, in response to receipt of said request for authorization, a request for confirmation to a messaging center associated with said wireless telephony system, said messaging center being operative to 1) transmit, in response to receipt of said request for confirmation, a message to said mobile device associated with said telephone number, said message including a request for a user of said mobile device to send a reply to said message to confirm said request for an electronic transaction, 2) receive at said messaging center a reply to said message from said mobile device, and 3) transmit said message to said transaction authorization system;
determining, from the content of said message, whether a user of said mobile device has confirmed said electronic transaction; and
transmitting, in response to a confirmation of said electronic transaction, a transaction authorization message to said vendor system.

13. The transaction authorization system recited in claim 12, wherein a request for said electronic transaction is transmitted to said vendor system from an electronic device other than said wireless device.

14. The transaction authorization system recited in claim 12, wherein a request for said electronic transaction is transmitted to said vendor system from said wireless telephone.

15. The transaction authorization system recited in claim 12, wherein messaging system associated with said wireless telephony system comprises a Short Message Service (SMS) center.

16. The transaction authorization system recited in claim 12, wherein said transaction authorization system further comprises a database for storing User Profiles, each User Profile including at least a telephone number and payment source information.

17. The transaction authorization system recited in claim 16, wherein said payment source information comprises a credit card number.

18. The transaction authorization system recited in claim 16, wherein said transaction authorization message includes said payment source information.

19. The transaction authorization system recited in claim 12, wherein said request for authorization, said request for confirmation, and said message to said wireless device each include a merchant identifier associated with said electronic transaction.

20. The transaction authorization system recited in claim 12, wherein said request for authorization, said request for confirmation, and said message to said wireless device each include the cost of said electronic transaction.

21. The transaction authorization system recited in claim 12, wherein said request for confirmation and said message to said wireless device include a request for said user to provide a user code.

22. The transaction authorization system recited in claim 21, wherein said digitally-coded instructions are further operative to cause said computing system to perform the steps of:
comparing said user code to a code stored in a User Profile; and
sending a transaction rejection message to said vendor system if said user code is not identical to said code stored in said User Profile.
